(19) United States
(12) Patent Application Publication
(10) Pub. No.: US 2021/0241533 A1
(43) Pub. Date: Aug. 5, 2021

(54) METHOD FOR PROVIDING AUGMENTED REALITY BASED ON MULTI-USER INTERACTION WITH REAL OBJECTS AND APPARATUS USING THE SAME

(71) Applicant: Electronics And Telecommunications Research Institute, Daejeon (KR)

(72) Inventor: Byung-Kuk SEO, Daejeon (KR)

(21) Appl. No.: 17/151,992

(22) Filed: Jan. 19, 2021

(30) Foreign Application Priority Data
Jan. 31, 2020 (KR) 10-2020-0011937

(51) Int. Cl. G06T 19/00; G06F 3/01

(52) U.S. Cl. CPC G06T 19/006; G06F 3/011

(57) ABSTRACT

Disclosed herein are a method for providing augmented reality based on participation of multiple users using interaction with a real object and an apparatus for the same. The method is configured such that an augmented reality provision apparatus identifies a target real object on which visual processing is to be performed based on the interaction between a virtual object and a real object in an augmented reality area, delivers instance information corresponding to the target real object to at least one additional user included in the augmented reality area, provides a target real object image corresponding to the view of a user by performing the visual processing at an instance level corresponding to the target real object, and provides an augmented reality event resulting from the interaction so as to correspond to the view of the user.

### CROSS REFERENCE TO RELATED APPLICATION

This application claims the benefit of Korean Patent Application No. 10-2020-0011937, filed Jan. 31, 2020, which is hereby incorporated by reference in its entirety into this application.

### BACKGROUND OF THE INVENTION

### 1. Technical Field

The present invention relates generally to technology for providing augmented reality in a multi-user environment, and more particularly to augmented reality technology for providing various types of interaction with a real object in an augmented reality environment in which multiple users participate.

### 2. Description of Related Art

With the recent emergence of augmented reality development solutions, such as Apple's ARKit and Google's ARCore, wearable augmented reality devices are quickly improving, which leads to rising interest in augmented reality service and applications using the same.

Augmented reality technology is technology for augmenting a virtual object as if it were present in an actual space based on the pose of a camera, such as the position or orientation thereof, estimated from an image of the actual space captured by the camera. Meanwhile, research on interaction between a virtual object and a user, that is, visual or haptic interaction between the augmented virtual object and a user, is actively underway.

However, most pieces of augmented reality content focus on interaction with an augmented virtual object, and a specific framework for interaction in a real space is not provided. Also, research on diminished-reality technology for making a real object invisible in the real space has been carried out, but there is a technical limitation in that invisibility is realized only for a single user. That is, processing the target area to be deleted, which is different when viewed from different viewpoints, so as to correspond to the respective viewpoints has not been achieved.

### DOCUMENTS OF RELATED ART

(Patent Document 1) Korean Patent No. 10-1740213, published on May 19, 2017 and titled “Device for playing responsive augmented reality card game by checking collision of virtual object”.

### SUMMARY OF THE INVENTION

An object of the present invention is to provide further improved interaction between users or objects in an augmented reality environment in which multiple users participate.

Another object of the present invention is to provide augmented reality content capable of providing a more realistic and rich experience.

A further object of the present invention is to enhance a virtual object including interaction with a real object so as to correspond to the views of respective users participating in an augmented reality environment, thereby providing a variety of more natural augmented reality content in a multi-user environment.

In order to accomplish the above objects, a method for providing augmented reality according to the present invention includes identifying, by an augmented reality provision apparatus, a target real object on which visual processing is to be performed based on interaction between a virtual object and a real object in an augmented reality area; delivering, by the augmented reality provision apparatus, instance information corresponding to the target real object to at least one additional user included in the augmented reality area; performing, by the augmented reality provision apparatus, the visual processing at an instance level corresponding to the target real object, thereby providing a target real object image corresponding to the view of a user; and providing, by the augmented reality provision apparatus, an augmented reality event resulting from the interaction so as to correspond to the view of the user.

Here, the visual processing may be performed based on the target real object viewed from the viewpoint of each of the at least one additional user.

Here, the visual processing may be performed so as to correspond to at least one of deformation of the real object, deletion thereof, and reconstruction thereof.

Here, the augmented reality event may be generated differently for the view of each of the at least one additional user and may be configured to provide augmented reality play information that is displayed so as to correspond to the view of each of the at least one additional user.

Here, the target real object image may be displayed in a different form, corresponding to the view of each of the at least one additional user, so as to correspond to the visual processing.

Here, the target real object may be identified by the augmented reality provision apparatus of the at least one additional user using the instance level of a 3D mesh reprojected based on the instance information.

Here, providing the target real object image may be configured to perform the reconstruction of the real object based on 3D structural information pertaining to the target real object.

Also, an apparatus for providing augmented reality according to an embodiment of the present invention includes a processor for identifying a target real object on which visual processing is to be performed based on interaction between a virtual object and a real object in an augmented reality area, delivering instance information corresponding to the target real object to at least one additional user included in the augmented reality area, providing a target real object image corresponding to the view of a user by performing the visual processing at an instance level corresponding to the target real object, and providing an augmented reality event resulting from the interaction so as to correspond to the view of the user; and memory for storing at least one of identification information corresponding to the target real object and the instance information.

Here, the visual processing may be performed based on the target real object viewed from the viewpoint of each of the at least one additional user.

Here, the visual processing may be performed so as to correspond to at least one of deformation of the real object, deletion thereof, and reconstruction thereof.

Here, the augmented reality event may be generated differently for the view of each of the at least one additional user and may be configured to provide augmented reality play information that is displayed so as to correspond to the view of each of the at least one additional user.

Here, the target real object image may be displayed in a different form, corresponding to the view of each of the at least one additional user, so as to correspond to the visual processing.

Here, the target real object may be identified by the augmented reality provision apparatus of the at least one additional user using the instance level of a 3D mesh reprojected based on the instance information.

Here, the processor may perform the reconstruction of the real object based on 3D structural information pertaining to the target real object.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a view illustrating a system for providing augmented reality based on multiple users using instance information according to an embodiment of the present invention;

FIG. 2 is a flowchart illustrating a method for providing augmented reality based on multiple users using instance information according to an embodiment of the present invention;

FIGS. 3 to 4 are views illustrating an example of augmented reality play information when viewed from the viewpoint of user 1 illustrated in FIG. 1;

FIGS. 5 to 6 are views illustrating an example of augmented reality play information when viewed from the viewpoint of user 4 illustrated in FIG. 1;

FIGS. 7 to 9 are views illustrating an example of the process of delivering instance information from user 1 to user 4 illustrated in FIG. 1;

FIGS. 10 to 15 are views illustrating an example of object deformation according to the present invention;

FIG. 16 is a view illustrating an example of the process of deforming an object and reconstructing the background of the object according to the present invention; and

FIG. 17 is a block diagram illustrating an apparatus for providing augmented reality based on multiple users using instance information according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

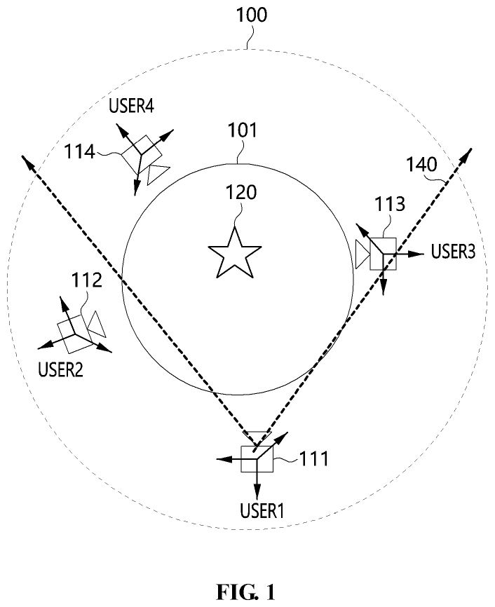

FIG. 1 is a view illustrating a system for providing augmented reality based on multiple users using instance information according to an embodiment of the present invention.

Referring to FIG. 1, the system for providing augmented reality based on multiple users using instance information according to an embodiment of the present invention includes an augmented reality area 100, a target area 101, which is a target for augmenting a virtual object 120 in the augmented reality area 100, multiple augmented reality provision apparatuses 111 to 114 used by multiple users included in the augmented reality area 100, and the augmented virtual object 120.

The augmented reality area 100 may be an area in which augmented reality content or augmented reality service is provided in a multi-user environment. Accordingly, the respective users carrying or wearing the augmented reality provision apparatuses 111 to 114 may use augmented reality content in the augmented reality area 100 through the augmented reality provision apparatuses 111 to 114.

Here, the target area 101 included in the augmented reality area 100 is an area in which multiple users included in the augmented reality area 100 actually use augmented reality content or augmented reality service according to an embodiment of the preset invention, and may be the area in which the virtual object 120 enhanced according to the augmented reality content or a real object interacting with the virtual object 120 is displayed.

That is, the multiple users included in the augmented reality area 100 direct the fields of view of the cameras installed in the respective augmented reality provision apparatuses 111-114 towards the target area 101, thereby identifying the virtual object 120 augmented in the target area 101 and the real object interacting with the virtual object 120.

Here, because the present invention provides augmented reality based on a multi-user environment, the multiple users are able to simultaneously use augmented reality content in the augmented reality area 100, as shown in FIG. 1. Accordingly, the users observe the virtual object 120 augmented in the target area 101 from their respective viewpoints, and the augmented reality-playing screens provided to the respective users may be different depending on the different viewpoints.

That is, the screen displayed when user 1 illustrated in FIG. 1 is looking at the virtual object 120 augmented in the target area 101 and the screen displayed when user 4 illustrated in FIG. 1 is looking at the same virtual object 120 may be different from each other, and may be provided to the respective augmented reality provision apparatuses 111 and 114.

For example, assuming that the augmented virtual object 120 has a shape, the front and back of which can be distinguished, and that the front thereof faces user 1, the screen of the augmented reality provision apparatus 111 of user 1 may show the front of the augmented virtual object 120, whereas the screen of the augmented reality provision apparatus 114 of user 4 may show the back of the augmented virtual object 120.

Also, the augmented reality provision apparatuses 111 to 114 respectively used by the multiple users identify a target real object on which visual processing is to be performed based on the interaction between the virtual object 120 and a real object in the augmented reality area.

Here, 3D structural information or 3D positional information pertaining to the target real object, which is the target on which visual processing is to be performed, may be acquired through the process of identifying the target real object.

Also, the augmented reality provision apparatuses 111 to 114 deliver instance information corresponding to the target real object to at least one additional user included in the augmented reality area.

Here, the augmented reality provision apparatuses 111 to 114 may wirelessly communicate with each other.

Also, the augmented reality provision apparatuses 111 to 114 may be terminals or wearable devices, and may be configured in the form of a server and a client. For example, the augmented reality provision apparatuses 111 to 114 may operate in the form of a cloud server and a client terminal.

Here, the target real object may be identified by the augmented reality provision apparatus of the at least one additional user using the instance level of a 3D mesh, reprojected based on the instance information.

Also, the augmented reality provision apparatuses 111 to 114 perform visual processing at the instance level corresponding to the target real object, thereby providing a target real object image corresponding to the views of the users.

Here, the visual processing may be performed based on the target real object, viewed from the viewpoint of each of the at least one additional user.

Here, the visual processing may be performed so as to correspond to at least one of deformation of the real object, deletion thereof, and reconstruction thereof.

Here, the target real object image may be displayed in a different form, corresponding to the view of each of the at least one additional user, so as to correspond to the visual processing.

Here, the target real object may be identified by the augmented reality provision apparatus of the at least one additional user using the instance level of a 3D mesh, reprojected based on the instance information.

Here, reconstruction of the real object may be performed based on 3D structural information pertaining to the target real object.

Also, the augmented reality provision apparatuses 111 to 114 provide an augmented reality event resulting from interaction so as to correspond to the views of the users.

Here, the augmented reality event may be differently generated for the view of each of the at least one additional user, and augmented reality play information that is displayed so as to correspond to the view of each of the at least one additional user may be provided.

As described above, the present invention provides augmented reality content or augmented reality service in consideration of the views of multiple users, thereby providing a more realistic experience to the users using the same.

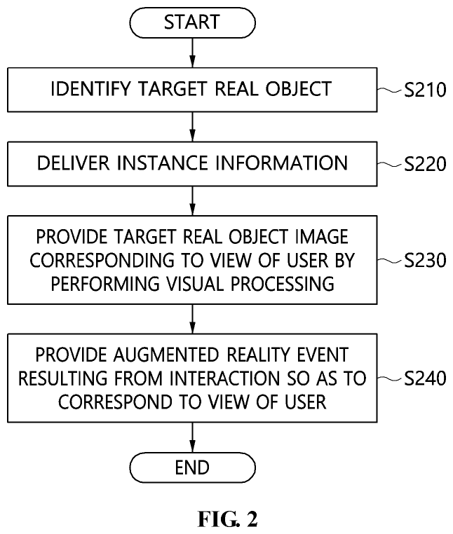

FIG. 2 is a flowchart illustrating a method for providing augmented reality based on multiple users using instance information according to an embodiment of the present invention.

Referring to FIG. 2, in the method for providing augmented reality based on multiple users using instance information according to an embodiment of the present invention, an augmented reality provision apparatus identifies a target real object on which visual processing is to be performed based on the interaction between a virtual object and a real object in an augmented reality area at step S210.

That is, the target real object may be a real object that interacts with a user or a virtual object in the augmented reality area.

To this end, whether a real object included in the augmented reality area interacts with a user or a virtual object may be determined first. For example, whether interaction in which a real object is selected through the user interface of the augmented reality provision apparatus, a virtual object collides with a real object while moving, a virtual object and a real object overlap each other and one of the objects is not visible, or the like occurs may be determined.

As described above, whether interaction occurs is determined, and when interaction occurs, the corresponding real object may be identified as the target real object.

Here, the target real object may be identified based on the view of the user who is using the augmented reality provision apparatus.

For example, the augmented reality provision apparatus may determine the view of the user by reconstructing 3D information pertaining to the real space corresponding to the augmented reality area and predicting posture information, such as the position or orientation of the user, using the 3D information. Then, the target real object included in the augmented reality area corresponding to the view of the user may be identified based on the predicted posture.

Here, the view of the user may correspond to the field of view of the camera of the augmented reality provision apparatus used or worn by the user.

Also, in the method for providing augmented reality based on multiple users using instance information according to an embodiment of the present invention, the augmented reality provision apparatus delivers instance information corresponding to the target real object to at least one additional user included in the augmented reality area at step S220.

The target real object may be identified by the augmented reality provision apparatus of the at least one additional user using the instance level of a 3D mesh reprojected based on the instance information.

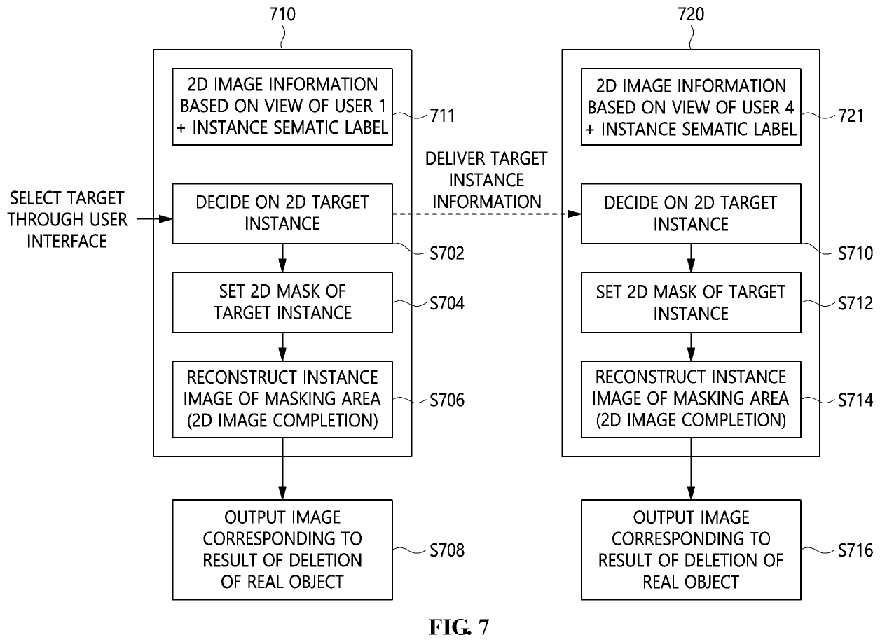

For example, when an augmented reality image in which a real object is simply deleted is provided, it may be assumed that user 1 illustrated in FIG. 1 selects the real object with which to interact (for deletion) in a 2D image through the user interface of the augmented reality provision apparatus 710, as shown in FIG. 7. At the instance level of the augmented reality provision apparatus 710 of user 1, the real object selected by user 1 is set as the 2D target instance to be deleted from the image, that is, the target object, at step S702, and information about the 2D target instance selected by user 1 may be delivered to the augmented reality provision apparatus 720 of user 4 for interaction between multiple users.

Here, FIG. 7 illustrates only unidirectional delivery from the augmented reality provision apparatus 710 of user 1 to the augmented reality provision apparatus 720 of user 4, but target instance information may also be delivered from the augmented reality provision apparatus 720 of user 4 to the augmented reality provision apparatus 710 of user 1 in the same manner.

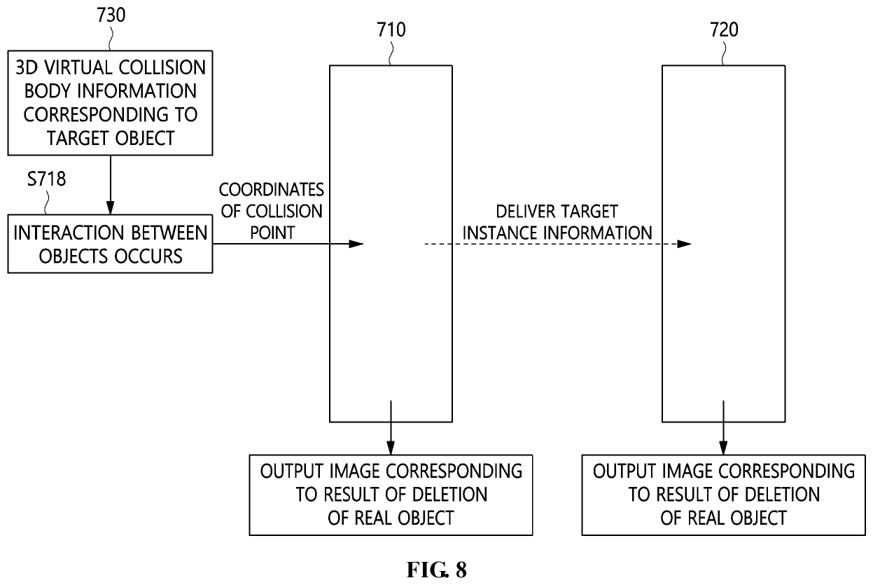

In another example, when an augmented reality image in which a real object is simply deleted is provided, 2D instance information of a target object that is selected through the interaction between objects, such as collision with a virtual object, rather than being selected through a user interface, may be delivered, as shown in FIG. 8. To this end, an additional step (S718) for determining whether a virtual object collides with the target object based on 3D virtual collision body information 730 corresponding to the target object may be further performed.

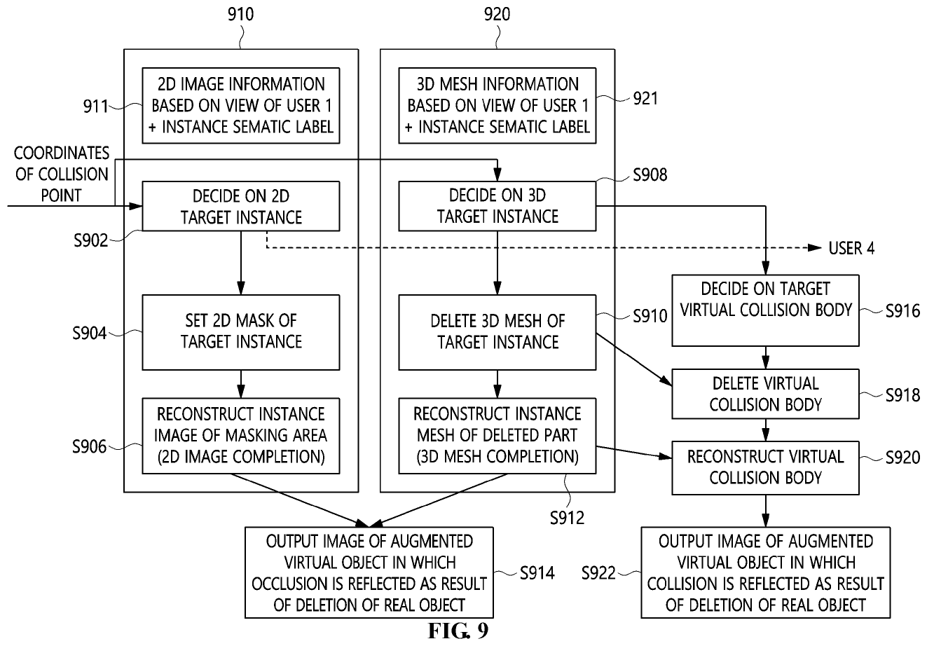

In another example, when an interaction in which, after deletion of a real object, an augmented virtual object is placed at or moves past the area from which the real object is deleted occurs, 3D target instance information, which is set using 3D mesh information based on the view of user 1 and an instance sematic label 921 at step S908, is delivered to user 4 along with the 2D target instance information, as shown in FIG. 9, whereby augmentation of the virtual object to which occlusion or collision is reflected in the area from which the real object is deleted may also be realized when viewed from the viewpoint of user 4. That is, the real object is deleted from the 2D image, but the actual 3D geometric information of the real object and the virtual collision body are not deleted. Therefore, 3D target instance information related thereto may also be delivered to other augmented reality provision apparatuses included in the multi-user environment.

Here, the situation shown in FIG. 9 may be the case in which 3D information of the target real object is not shared in real time. That is, this may be the case in which, after a system is launched, the augmented reality provision apparatuses of the respective users store an already reconstructed 3D mesh by receiving the same from a server and use the same individually. Accordingly, the augmented reality provision apparatus of user 4 may also perform the same process as the process performed by the augmented reality provision apparatus 920 of user 1 illustrated in FIG. 9.

Here, FIG. 9 also illustrates only unidirectional delivery from the augmented reality provision apparatus of user 1 to the augmented reality provision apparatus of user 4, but 3D target instance information may also be delivered from the augmented reality provision apparatus of user 4 to the augmented reality provision apparatus of user 1 in the same manner.

Also, in the method for providing augmented reality based on multiple users using instance information according to an embodiment of the present invention, the augmented reality provision apparatus performs visual processing at an instance level corresponding to the target real object, thereby providing a target real object image corresponding to the view of the user at step S230.

Here, the visual processing may be performed based on the target real object viewed from the viewpoint of each of the at least one additional user.

Here, the visual processing may be performed so as to correspond to at least one of deformation of a real object, deletion thereof, and reconstruction thereof.

Here, the target real object image may be displayed in a different form, corresponding to the view of each of the at least one additional user, so as to correspond to the visual processing.

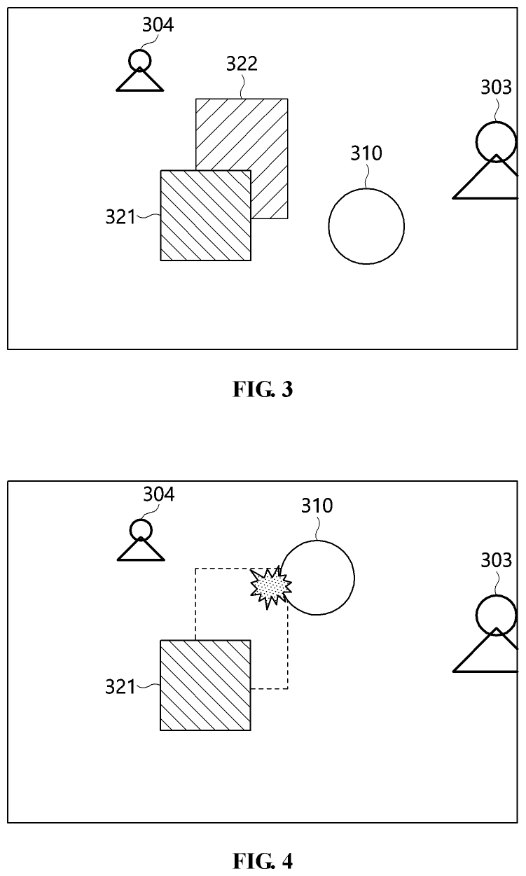

For example, it may be assumed that the augmented reality screen shown in FIG. 3 is displayed to user 1 in the environment illustrated in FIG. 1. Referring to FIG. 3, it can be seen that user 3 303 and user 4 304 are viewed from the viewpoint of user 1, depending on the locations of the users. Here, visual processing may be performed based on the two real objects 321 and 322 shown in FIG. 3. If the virtual object 310 shown in FIG. 3 moves and collides with the real object 322, visual processing by which the real object 322 is deleted may be performed, as shown in FIG. 4, and a target real object image may be generated in response thereto and output to user 1.

Here, the real object 322 is identified as the target real object, and visual processing may be performed thereon such that the entirety thereof is deleted after interaction with the virtual object 310, as shown in FIG. 4, or such that only the part thereof colliding with the virtual object 310 is deleted.

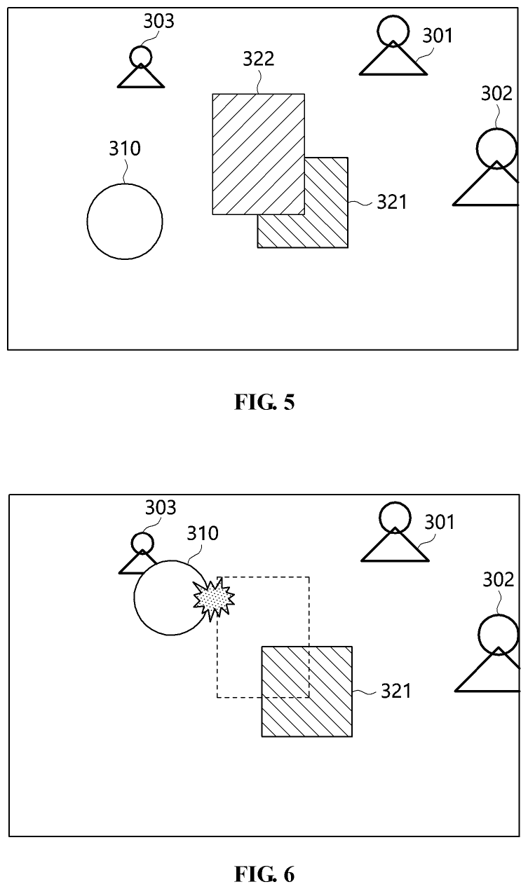

Here, the augmented reality screen shown in FIGS. 5 to 6 may be displayed to user 4, who is included in the same augmented reality area as user 1. Here, FIG. 5 corresponds to the augmented reality screen that shows the situation illustrated in FIG. 3 when viewed from the viewpoint of user 4, and it can be seen that the real object 322 is displayed in a manner that hides the real object 321, unlike in FIG. 3. That is, because the real object 321 is placed closer to the front when viewed from the viewpoint of user 1 301, the real object 321 is displayed so as to hide the real object 322, but this may be viewed in reverse from the viewpoint of user 4.

Accordingly, referring to FIG. 6, which shows the situation illustrated in FIG. 4 when viewed from the viewpoint of user 4, it can be seen that interaction in which the virtual object 310 collides with the real object 322 causes not only deletion of the real object 322, identified as the target real object, but also reconstruction of the part of the real object 321 that was hidden by the real object 322. That is, when viewed from the viewpoint of user 1 301, only visual processing by which the real object 322 is deleted is performed, but when viewed from the viewpoint of user 4, visual processing by which a portion of the real object 321 is reconstructed simultaneously with deletion of the real object 322 may be performed.

Here, in order to delete or reconstruct a real object as shown in FIG. 4 or FIG. 6, inpainting or completion technology may be used. To this end, the present invention may perform segmentation of each real object area, and may use reconstructed 3D information when 3D structural information pertaining to a partially hidden part is required.

Here, the real-object deletion process illustrated in FIGS. 3 to 6 is described in detail with reference to FIGS. 7 to 9 below.

First, the process in which a target real object is identified by the augmented reality provision apparatus of user 1 may be performed through the step (S718) of determining whether a virtual object collides with the target real object based on the 3D virtual collision body information 730, as described above with reference to FIG. 8.

Then, referring to FIG. 7, a 2D target instance is selected based on 2D image information based on the view of user 1 and an instance sematic label 711 at step S702, and an instance level corresponding to the selected 2D target instance may be defined as a mask at step S704.

Then, the augmented reality provision apparatus 710 of user 1 performs 2D image completion for the mask area at step S706, thereby generating a target real object image from which the real object corresponding to the target real object is deleted at step S708.

Here, the augmented reality provision apparatus 720 of user 4 may set a 2D target instance, that is, the target real object to be deleted, in the 2D image viewed from the viewpoint of user 4 at step S710 using the 2D target instance information received from the augmented reality provision apparatus 710 of user 1.

Then, the augmented reality provision apparatus 720 of user 4 may also define an instance area for the target real object as a mask in the same manner at step S712, and may generate and provide an image in which the target real object deleted by user 1 is also deleted when viewed from the viewpoint of user 4 at steps S714 and S716.

Here, the process of delivering the target instance information from the augmented reality provision apparatus 710 of user 1 to the augmented reality provision apparatus 720 of user 4 may include a process in which information corresponding to the 3D mesh of a target real space is set using a sample point in the instance area set by the augmented reality provision apparatus 710 of user 1 and is then reprojected onto the view of user 4. That is, because the target instance information delivered to the augmented reality provision apparatus 720 of user 4 includes the instance level of the reprojected 3D mesh, the target real object corresponding to the 2D target instance may also be identified in the 2D image viewed from the viewpoint of user 4.

Also, referring to FIG. 9, the present invention is configured such that a 3D target instance for interaction is set at step S908 using the 3D mesh information based on the view of user 1 and an instance semantic label 921, the 3D mesh of the set 3D target instance is deleted at step S910, and 3D mesh completion for the instance is performed at step S912, whereby an image of the augmented virtual object in which occlusion is reflected may be output at step S914.

That is, the present invention may delete the virtual collision body corresponding to the target real object at step S918, as illustrated in FIG. 9, and may augment the virtual object in the area from which the real object is deleted by reflecting collision processing thereto at step S922.

Here, the augmented reality provision apparatus of user 4 may also perform processing corresponding to the view of user 4 using the target instance information received from the augmented reality provision apparatus of user 1.

Here, reconstruction of the real object may be performed based on 3D structural information pertaining to the target real object.

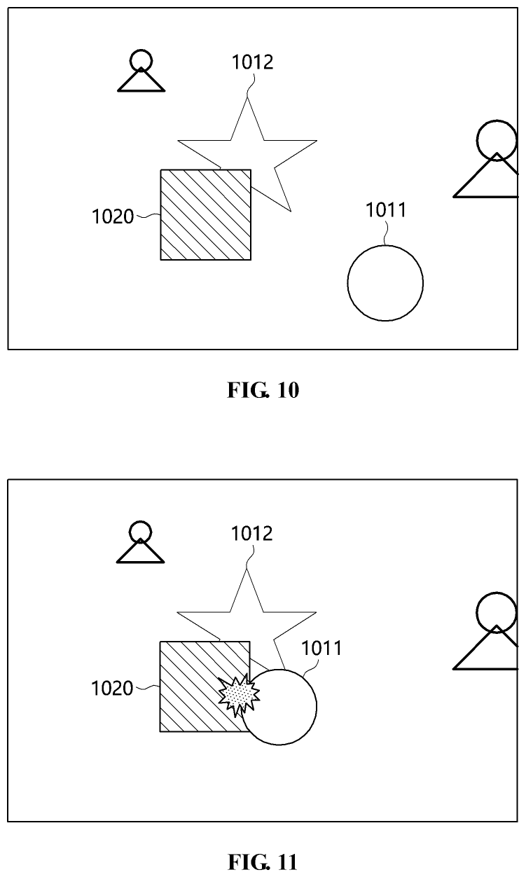

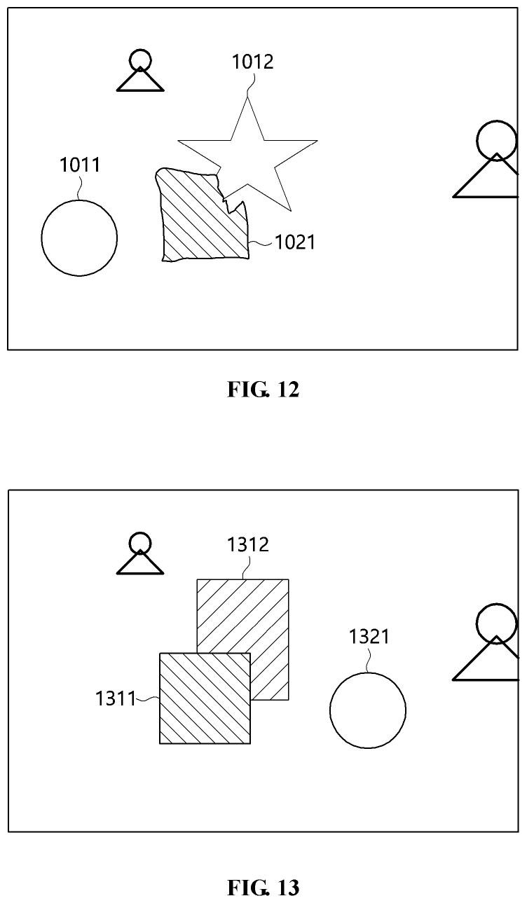

For example, it may be assumed that an augmented reality event occurs based on two virtual objects 1011 and 1012 and a single real object 1020, as shown in FIG. 10. If the virtual object 1011 moves, collides with the real object 1020, and moves again, as shown in FIG. 11, visual processing by which the shape of the real object 1020 illustrated in FIGS. 10 to 11 is changed to the shape of the real object 1021 illustrated in FIG. 12 may be performed, as shown in FIG. 12. Here, when the shape of the real object 1021 is changed, augmented reality play information in which the part of the virtual object 1012 that was hidden by the real object 1021 is reconstructed may be generated and used for play.

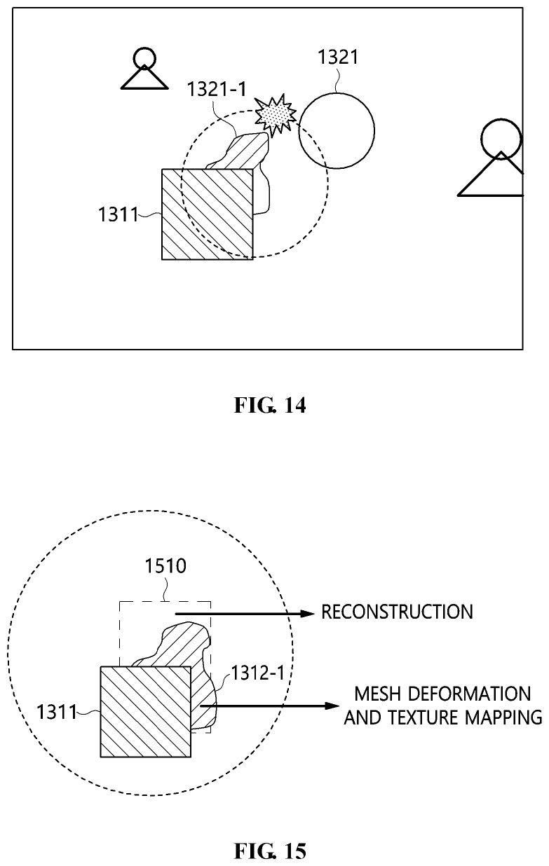

In another example, it may be assumed that the interaction illustrated in FIG. 14 occurs based on the two real objects 1311 and 1312 and the single virtual object 1321 illustrated in FIG. 13. Here, it can be seen that the real object 1312 is deformed after collision with the virtual object 1321, as shown in FIG. 14.

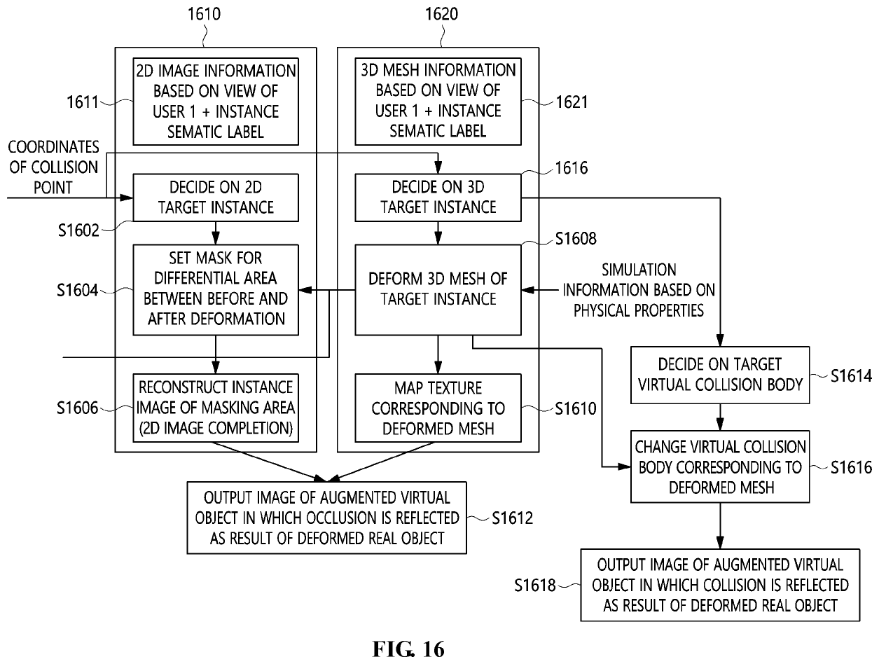

Describing this process in detail with reference to FIG. 16, the augmented reality provision apparatus according to an embodiment of the present invention may perform mesh deformation for the real object 1312, which is the target object, and texture mapping corresponding to the deformed mesh at steps S1608 and S1610 using a simulation based on physical properties.

Here, through the process of reconstructing the differential area generated between the area corresponding to the contour 1510 of the target real object and the area corresponding to the deformed target real object 1312-1, as shown in FIG. 15, an augmented reality image in which occlusion by the deformed target real object 1312-1 is reflected may be output at step S1612.

Here, deformation of the real object, such as breakage, warpage, or the like, may be performed in any of various ways based on the physical properties of the real object.

Here, the remaining steps illustrated in FIG. 16 may be performed similar to the steps described above with reference to FIG. 9.

Also, in the method for providing augmented reality based on multiple users using instance information according to an embodiment of the present invention, the augmented reality provision apparatus provides an augmented reality event resulting from interaction so as to correspond to the view of the user at step S240.

Here, the augmented reality event may be generated differently for the view of each of the at least one additional user, and augmented reality play information displayed so as to correspond to the view of each of the at least one additional user may be provided.

That is, the augmented reality play information may be individually displayed to multiple users based on the augmented reality provision apparatuses of the multiple users.

Here, a virtual object may be augmented in different forms for the multiple users based on the respective viewpoints of the multiple users.

For example, on the assumption that four users are disposed, as shown in FIG. 1, the augmented reality screen shown in FIG. 3 may be displayed to user 1. Referring to FIG. 3, it can be seen that user 3 303 and user 4 304 are viewed from the viewpoint of user 1 due to the disposition of the users. Here, an augmented reality event may occur based on the two real objects 321 and 322 or the single virtual object 310 illustrated in FIG. 3. If the virtual object 310 illustrated in FIG. 3 moves and collides with the real object 322, an augmented reality event by which the real object 322 is deleted, as shown in FIG. 4, may occur, and augmented reality play information for this event may be generated and played for user 1.

Also, although not illustrated in FIG. 2, in the method for providing augmented reality based on multiple users using instance information according to an embodiment of the present invention, various kinds of information generated during the above-described process of providing augmented reality according to an embodiment of the present invention may be stored.

Through the above-described method for providing augmented reality based on multiple users, further improved interaction between users or objects may be provided in an augmented reality environment in which multiple users participate.

Also, augmented reality content capable of providing a more realistic and rich experience may be provided.

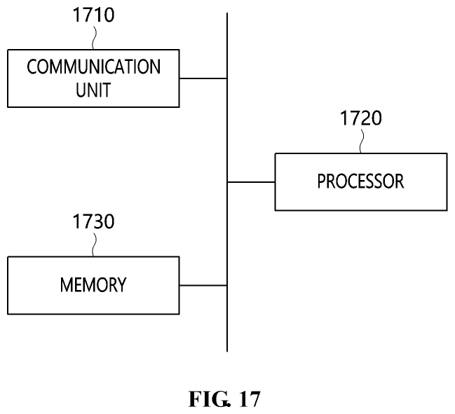

FIG. 17 is a block diagram illustrating an apparatus for providing augmented reality based on multiple users using instance information according to an embodiment of the present invention.

Referring to FIG. 17, the apparatus for providing augmented reality based on multiple users using instance information according to an embodiment of the present invention includes a communication unit 1710, a processor 1720, and memory 1730.

The communication unit 1710 may serve to transmit and receive data required for providing augmented reality based on multiple users through a communication network. Particularly, the communication unit 1710 according to an embodiment of the present invention may transmit and receive data required for providing augmented reality to and from the augmented reality provision apparatus of another user based on wireless communication.

The processor 1720 identifies a target real object on which visual processing is to be performed based on the interaction between a virtual object and a real object in an augmented reality area.

That is, the target real object may be a real object that interacts with a user or a virtual object in the augmented reality area.

To this end, whether a real object included in the augmented reality area interacts with a user or a virtual object may be determined first. For example, whether interaction in which a real object is selected through the user interface of the augmented reality provision apparatus, a virtual object collides with a real object while moving, a virtual object and a real object overlap each other and one of the objects is not visible, or the like occurs may be determined.

As described above, whether interaction occurs is determined, and when interaction occurs, the corresponding real object may be identified as the target real object.

Here, the target real object may be identified based on the view of the user using the augmented reality provision apparatus.

For example, the augmented reality provision apparatus may determine the view of the user by reconstructing 3D information pertaining to the real space corresponding to the augmented reality area and predicting posture information, such as the position or orientation of the user, using the 3D information. Then, the target real object included in the augmented reality area corresponding to the view of the user may be identified based on the predicted posture.

Here, the view of the user may correspond to the field of view of the camera of the augmented reality provision apparatus used or worn by the user.

Also, the processor 1720 delivers instance information corresponding to the target real object to at least one additional user included in the augmented reality area.

The target real object may be identified by the augmented reality provision apparatus of the at least one additional user using the instance level of a 3D mesh reprojected based on the instance information.

For example, when an augmented reality image in which a real object is simply deleted is provided, it may be assumed that user 1 illustrated in FIG. 1 selects the real object with which to interact (for deletion) in a 2D image through the user interface of the augmented reality provision apparatus 710, as shown in FIG. 7. At the instance level of the augmented reality provision apparatus 710 of user 1, the real object selected by user 1 is set as the 2D target instance to be deleted from the image, that is, the target object, at step S702, and information about the 2D target instance selected by user 1 may be delivered to the augmented reality provision apparatus 720 of user 4 for interaction between multiple users.

Here, FIG. 7 illustrates only unidirectional delivery from the augmented reality provision apparatus 710 of user 1 to the augmented reality provision apparatus 720 of user 4, but target instance information may also be delivered from the augmented reality provision apparatus 720 of user 4 to the augmented reality provision apparatus 710 of user 1 in the same manner.

In another example, when an augmented reality image in which a real object is simply deleted is provided, 2D instance information of a target object that is selected through the interaction between objects, such as collision with a virtual object, rather than being selected through a user interface, may be delivered, as shown in FIG. 8. To this end, an additional step (S718) for determining whether a virtual object collides with the target object based on 3D virtual collision body information 730 corresponding to the target object may be further performed.

In another example, when an interaction in which, after deletion of a real object, an augmented virtual object is placed at or moves past the area from which the real object is deleted occurs, 3D target instance information, which is set using 3D mesh information based on the view of user 1 and an instance sematic label 921 at step S908, is delivered to user 4 along with the 2D target instance information, as shown in FIG. 9, whereby augmentation of the virtual object, to which occlusion or collision is reflected, in the area from which the real object is deleted may also be realized when viewed from the viewpoint of user 4. That is, the real object is deleted from the 2D image, but the actual 3D geometric information of the real object and the virtual collision body are not deleted. Therefore, 3D target instance information related thereto may also be delivered to other augmented reality provision apparatuses included in the multi-user environment.

Here, the situation illustrated in FIG. 9 may be the case in which 3D information of the target real object is not shared in real time. That is, this may be the case in which, after a system is launched, the augmented reality provision apparatuses of the respective users store an already reconstructed 3D mesh by receiving the same from a server and use the same individually. Accordingly, the augmented reality provision apparatus of user 4 may also perform the same process as the process performed by the augmented reality provision apparatus 920 of user 1 illustrated in FIG. 9.

Here, FIG. 9 also illustrates only unidirectional delivery from the augmented reality provision apparatus of user 1 to the augmented reality provision apparatus of user 4, but 3D target instance information may also be delivered from the augmented reality provision apparatus of user 4 to the augmented reality provision apparatus of user 1 in the same manner.

Also, the processor 1720 performs visual processing at an instance level corresponding to the target real object, thereby providing a target real object image corresponding to the view of the user.

Here, the visual processing may be performed based on the target real object viewed from the viewpoint of each of the at least one additional user.

Here, the visual processing may be performed so as to correspond to at least one of deformation of a real object, deletion thereof, and reconstruction thereof.

Here, the target real object image may be displayed in a different form, corresponding to the view of each of the at least one additional user, so as to correspond to the visual processing.

For example, it may be assumed that the augmented reality screen shown in FIG. 3 is displayed to user 1 in the environment illustrated in FIG. 1. Referring to FIG. 3, it can be seen that user 3 303 and user 4 304 are viewed from the viewpoint of user 1, depending on the locations of the users. Here, visual processing may be performed based on the two real objects 321 and 322 shown in FIG. 3. If the virtual object 310 shown in FIG. 3 moves and collides with the real object 322, visual processing by which the real object 322 is deleted may be performed, as shown in FIG. 4, and a target real object image may be generated in response thereto and output to user 1.

Here, the real object 322 is identified as the target real object, and visual processing may be performed thereon such that the entirety thereof is deleted after interaction with the virtual object 310, as shown in FIG. 4, or such that only the part thereof colliding with the virtual object 310 is deleted.

Here, the augmented reality screen shown in FIGS. 5 to 6 may be displayed to user 4, who is included in the same augmented reality area as user 1. Here, FIG. 5 corresponds to the augmented reality screen that shows the situation illustrated in FIG. 3 when viewed from the viewpoint of user 4, and it can be seen that the real object 322 is displayed in a manner that hides the real object 321, unlike in FIG. 3. That is, because the real object 321 is placed closer to the front when viewed from the viewpoint of user 1 301, the real object 321 is displayed so as to hide the real object 322, but this may be viewed in reverse from the viewpoint of user 4.

Accordingly, referring to FIG. 6, which shows the situation illustrated in FIG. 4 when viewed from the viewpoint of user 4, it can be seen that interaction in which the virtual object 310 collides with the real object 322 causes not only deletion of the real object 322, identified as the target real object, but also reconstruction of the part of the real object 321 that was hidden by the real object 322. That is, when viewed from the viewpoint of user 1 301, only visual processing by which the real object 322 is deleted is performed, but when viewed from the viewpoint of user 4, visual processing by which a portion of the real object 321 is reconstructed simultaneously with deletion of the real object 322 may be performed.

Here, in order to delete or reconstruct a real object as shown in FIG. 4 or FIG. 6, inpainting or completion technology may be used. To this end, the present invention may perform segmentation of each real object area, and may use reconstructed 3D information when 3D structural information pertaining to a partially hidden part is required.

Here, the real-object deletion process illustrated in FIGS. 3 to 6 is described in detail with reference to FIGS. 7 to 9 below.

First, the process in which a target real object is identified by the augmented reality provision apparatus of user 1 may be performed through the step (S718) of determining whether a virtual object collides with the target real object based on the 3D virtual collision body information 730, as described above with reference to FIG. 8.

Then, referring to FIG. 7, a 2D target instance is selected based on 2D image information based on the view of user 1 and an instance sematic label 711 at step S702, and an instance level corresponding to the selected 2D target instance may be defined as a mask at step S704.

Then, the augmented reality provision apparatus 710 of user 1 performs 2D image completion for the mask area at step S706, thereby generating a target real object image from which the real object corresponding to the target real object is deleted at step S708.

Here, the augmented reality provision apparatus 720 of user 4 may set a 2D target instance, that is, the target real object to be deleted, in the 2D image viewed from the viewpoint of user 4 at step S710 using the 2D target instance information received from the augmented reality provision apparatus 710 of user 1.

Then, the augmented reality provision apparatus 720 of user 4 may also define an instance area for the target real object as a mask in the same manner at step S712, and may generate and provide an image in which the target real object deleted by user 1 is also deleted when viewed from the viewpoint of user 4 at steps S714 and S716.

Here, the process of delivering the target instance information from the augmented reality provision apparatus 710 of user 1 to the augmented reality provision apparatus 720 of user 4 may include a process in which information corresponding to the 3D mesh of a target real space is set using a sample point in the instance area set by the augmented reality provision apparatus 710 of user 1 and is then reprojected onto the view of user 4. That is, because the target instance information delivered to the augmented reality provision apparatus 720 of user 4 includes the instance level of the reprojected 3D mesh, the target real object corresponding to the 2D target instance may also be identified in the 2D image viewed from the viewpoint of user 4.

Also, referring to FIG. 9, the present invention is configured such that a 3D target instance for interaction is set at step S908 using the 3D mesh information based on the view of user 1 and an instance semantic label 921, the 3D mesh of the set 3D target instance is deleted at step S910, and 3D mesh completion for the instance is performed at step S912, whereby an image of the augmented virtual object in which occlusion is reflected may be output at step S914.

That is, the present invention may delete the virtual collision body corresponding to the target real object at step S918, as illustrated in FIG. 9, and may augment the virtual object in the area from which the real object is deleted by reflecting collision processing thereto at step S922.

Here, the augmented reality provision apparatus of user 4 may also perform processing corresponding to the view of user 4 using the target instance information received from the augmented reality provision apparatus of user 1.

Here, reconstruction of the real object may be performed based on the 3D structural information pertaining to the target real object.

For example, it may be assumed that an augmented reality event occurs based on two virtual objects 1011 and 1012 and a single real object 1020, as shown in FIG. 10. If the virtual object 1011 moves, collides with the real object 1020, and moves again, as shown in FIG. 11, visual processing by which the shape of the real object 1020 illustrated in FIGS. 10 to 11 is changed to the shape of the real object 1021 illustrated in FIG. 12 may be performed, as shown in FIG. 12. Here, when the shape of the real object 1021 is changed, augmented reality play information in which the part of the virtual object 1012 that was hidden by the real object 1021 is reconstructed may be generated and used for play.

In another example, it may be assumed that the interaction illustrated in FIG. 14 occurs based on the two real objects 1311 and 1312 and the single virtual object 1321 illustrated in FIG. 13. Here, it can be seen that the real object 1312 is deformed after collision with the virtual object 1321, as shown in FIG. 14.

Describing this process in detail with reference to FIG. 16, the augmented reality provision apparatus according to an embodiment of the present invention may perform mesh deformation for the real object 1312, which is the target object, and texture mapping corresponding to the deformed mesh at steps S1608 and S1610 using a simulation based on physical properties.

Here, through the process of reconstructing the differential area generated between the area corresponding to the contour 1510 of the target real object and the area corresponding to the deformed target real object 1312-1, as shown in FIG. 15, an augmented reality image in which occlusion by the deformed target real object 1312-1 is reflected may be output at step S1612.

Here, deformation of the real object, such as breakage, warpage, or the like, may be performed in any of various ways based on the physical properties of the real object.

Here, the remaining steps illustrated in FIG. 16 may be performed similar to the steps described above with reference to FIG. 9.

Also, the processor 1720 provides an augmented reality event resulting from interaction so as to correspond to the view of the user.

Here, the augmented reality event may be generated differently for the view of each of the at least one additional user, and augmented reality play information displayed so as to correspond to the view of each of the at least one additional user may be provided.

That is, the augmented reality play information may be individually displayed to multiple users based on the augmented reality provision apparatuses of the multiple users.

Here, a virtual object may be augmented in different forms for the multiple users based on the respective viewpoints of the multiple users.

For example, on the assumption that four users are disposed, as shown in FIG. 1, the augmented reality screen shown in FIG. 3 may be displayed to user 1. Referring to FIG. 3, it can be seen that user 3 303 and user 4 304 are viewed from the viewpoint of user 1 due to the disposition of the users. Here, an augmented reality event may occur based on the two real objects 321 and 322 or the single virtual object 310 illustrated in FIG. 3. If the virtual object 310 illustrated in FIG. 3 moves and collides with the real object 322, an augmented reality event by which the real object 322 is deleted as shown in FIG. 4 may occur, and augmented reality play information for this event may be generated and played for user 1.

The memory 1730 stores at least one of identification information and instance information corresponding to the target real object.

Also, the memory 1730 stores various kinds of information generated during the above-described process of providing augmented reality according to an embodiment of the present invention.

According to an embodiment, the memory 1730 may be separate from the apparatus for providing augmented reality, and may support functions for providing augmented reality. Here, the memory 1730 may operate as separate mass storage, and may include a control function for performing operations.

Meanwhile, the apparatus for providing augmented reality includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage device.

Also, the apparatus for providing augmented reality may be a terminal or a wearable device, and may be configured in the form of a server and a client. For example, the apparatus for providing augmented reality may operate in the form of a cloud server and a client terminal.

Using the above-described apparatus for providing augmented reality based on multiple users, further improved interaction between users or objects may be provided in an augmented reality environment in which multiple users participate.

Also, augmented reality content capable of providing a more realistic and rich experience may be provided.

According to the present invention, further improved interaction between users or objects may be provided in an augmented reality environment in which multiple users participate.

Also, the present invention may provide augmented reality content capable of providing a more realistic and rich experience.

Also, the present invention enhances a virtual object including interaction with a real object so as to correspond to the views of respective users included in an augmented reality environment, thereby providing a variety of more natural augmented reality content in a multi-user environment.

As described above, the method for providing augmented reality based on participation of multiple users using interaction with a real object and the apparatus for the same according to the present invention are not limitedly applied to the configurations and operations of the above-described embodiments, but all or some of the embodiments may be selectively combined and configured, so the embodiments may be modified in various ways.

What is claimed is:

1. A method for providing augmented reality, comprising:
identifying, by an augmented reality provision apparatus, a target real object on which visual processing is to be performed based on interaction between a virtual object and a real object in an augmented reality area;
delivering, by the augmented reality provision apparatus, instance information corresponding to the target real object to at least one additional user included in the augmented reality area;
performing, by the augmented reality provision apparatus, the visual processing at an instance level corresponding to the target real object, thereby providing a target real object image corresponding to a view of a user; and
providing, by the augmented reality provision apparatus, an augmented reality event resulting from the interaction so as to correspond to the view of the user.

2. The method of claim 1, wherein the visual processing is performed based on the target real object viewed from a viewpoint of each of the at least one additional user.

3. The method of claim 1, wherein the visual processing is performed so as to correspond to at least one of deformation of the real object, deletion thereof, and reconstruction thereof.

4. The method of claim 1, wherein the augmented reality event is generated differently for a view of each of the at least one additional user and is configured to provide augmented reality play information that is displayed so as to correspond to the view of each of the at least one additional user.

5. The method of claim 1, wherein the target real object image is displayed in a different form, corresponding to a view of each of the at least one additional user, so as to correspond to the visual processing.

6. The method of claim 1, wherein the target real object is identified by an augmented reality provision apparatus of the at least one additional user using an instance level of a 3D mesh reprojected based on the instance information.

7. The method of claim 3, wherein providing the target real object image is configured to perform the reconstruction of the real object based on 3D structural information pertaining to the target real object.

8. An apparatus for providing augmented reality, comprising:
a processor for identifying a target real object on which visual processing is to be performed based on interaction between a virtual object and a real object in an augmented reality area, delivering instance information corresponding to the target real object to at least one additional user included in the augmented reality area, providing a target real object image corresponding to a view of a user by performing the visual processing at an instance level corresponding to the target real object, and providing an augmented reality event resulting from the interaction so as to correspond to the view of the user; and
memory for storing at least one of identification information corresponding to the target real object and the instance information.

9. The apparatus of claim 8, wherein the visual processing is performed based on the target real object viewed from a viewpoint of each of the at least one additional user.

10. The apparatus of claim 8, wherein the visual processing is performed so as to correspond to at least one of deformation of the real object, deletion thereof, and reconstruction thereof.

11. The apparatus of claim 8, wherein the augmented reality event is generated differently for a view of each of the at least one additional user and is configured to provide augmented reality play information that is displayed so as to correspond to the view of each of the at least one additional user.

12. The apparatus of claim 8, wherein the target real object image is displayed in a different form, corresponding to a view of each of the at least one additional user, so as to correspond to the visual processing.

13. The apparatus of claim 8, wherein the target real object is identified by an augmented reality provision apparatus of the at least one additional user using an instance level of a 3D mesh reprojected based on the instance information.

14. The apparatus of claim 10, wherein the processor performs the reconstruction of the real object based on 3D structural information pertaining to the target real object.
